(19) United States
(12) Patent Application Publication
(10) Pub. No.: US 2026/0160992 A1
(43) Pub. Date: Jun. 11, 2026

(54) SCANNING OPTICAL FIBER, LASER IRRADIATION DEVICE, AND METHOD FOR MANUFACTURING SCANNING OPTICAL FIBER

(71) Applicant: OLYMPUS CORPORATION, Tokyo (JP)

(72) Inventor: Takumi HAYASHI, Gunma (JP)

(73) Assignee: OLYMPUS CORPORATION, Tokyo (JP)

(21) Appl. No.: 19/360,126

(22) Filed: Oct. 16, 2025

Related U.S. Application Data
(63) Continuation of application No. PCT/JP2023/015880, filed on Apr. 21, 2023.

(51) Int. Cl. G02B 26/10; H01S 3/00

(52) U.S. Cl. CPC G02B 26/103; H01S 3/005

(57) ABSTRACT

A scanning optical fiber includes: a fiber core having a proximal region and a distal region; and a cover member formed of a single seamless member and covering at least a portion of the core. The cover member includes a tubular main section that covers at least a portion of the distal region excluding an end portion of the core, a protrusion protruding from a distal end of the main section at only one side of the core in a radial direction and arranged alongside the end portion in the radial direction, and a large diameter section provided at a proximal side relative to the distal end of the main section and folded in a longitudinal direction of the main section into a shape that protrudes radially outward.

### CROSS-REFERENCE TO RELATED APPLICATIONS

This is a continuation of International Application PCT/JP2023/015880 which is hereby incorporated by reference herein in its entirety.

### Technical Field

The present disclosure relates to scanning optical fibers, laser irradiation devices, and methods for manufacturing scanning optical fibers.

### Background Art

Known lithotripsy in the related art involves using laser light to fragment a calculus occurring in, for example, a kidney (e.g., see Non Patent Literature 1 and Patent Literature 1). In order to efficiently fragment the calculus, it is preferable to irradiate the calculus with the laser light while scanning the laser light.

Non Patent Literature 1 and Patent Literature 1 each disclose a scanning optical fiber that scans laser light by vibrating a distal end of the optical fiber. In Non Patent Literature 1, a magnet bead fixed to the optical fiber and a solenoid in the vicinity of the optical fiber are used to vibrate the distal end of the optical fiber by means of a magnetic force. In Patent Literature 1, a plate-shaped operation member disposed in the vicinity of the optical fiber is used to cause the distal end of the optical fiber to vibrate due to contraction of a bubble generated at the distal end of the optical fiber by means of the laser light.

### CITATION LIST

### Non Patent Literature

### NPL 1

Layton A. Hall, two others, “Thulium fiber laser stone dusting using an automated, vibrating optical fiber”, Proceedings SPIE 10852, Therapeutics and Diagnostics in Urology 2019, Feb. 26, 2019

### Patent Literature

### PTL 1

PCT International Publication No. WO 2022/190259

### SUMMARY OF DISCLOSURE

An aspect of the present disclosure provides a scanning optical fiber including: a fiber core having a proximal region and a distal region; and a cover member formed of a single seamless member and covering at least a portion of the fiber core. The cover member includes a tubular main section that covers at least a portion of the distal region excluding an end portion including a distal end of the fiber core, a protrusion that protrudes from a distal end of the main section at only one side of the fiber core in a radial direction and that is arranged alongside the end portion in the radial direction, and a large diameter section provided at a proximal side relative to the distal end of the main section and folded in a longitudinal direction of the main section into a shape that protrudes radially outward.

Another aspect of the present disclosure provides a scanning optical fiber including: a fiber core having a proximal region and a distal region; and a cover member formed by processing a single tubular member and covering at least a portion of the fiber core. The cover member includes a protrusion having a first notch extending in a longitudinal direction in a first region including a distal end of the tubular member, the protrusion being formed by causing at least a portion of the first region to deform in a direction in which the first region increases in distance from the fiber core in a radial direction, and a large diameter section having a second notch extending in the longitudinal direction in a second region of the tubular member, the second region being located at a proximal side relative to the first region, the large diameter section being formed by compressing the second region in the longitudinal direction and folding the second region into a shape that protrudes radially outward.

Another aspect of the present disclosure provides a laser irradiation device including: a laser light source that emits laser light; and a scanning optical fiber connected to the laser light source. The scanning optical fiber includes a connector attachable to and detachable from the laser light source, a fiber core connected to the connector and having a proximal region and a distal region, and a cover member formed of a single seamless member and covering at least a portion of the fiber core. The cover member includes a tubular main section that covers at least a portion of the distal region excluding an end portion including a distal end of the fiber core, a protrusion that protrudes from a distal end of the main section at only one side of the fiber core in a radial direction and that is arranged alongside the end portion in the radial direction, and a large diameter section provided at a proximal side relative to the distal end of the main section and folded in a longitudinal direction of the main section into a shape that protrudes radially outward.

Another aspect of the present disclosure provides a laser irradiation device including: a laser light source that emits laser light; and a scanning optical fiber connected to the laser light source. The scanning optical fiber includes a connector attachable to and detachable from the laser light source, a fiber core connected to the connector and having a proximal region and a distal region, and a cover member covering at least a portion of the fiber core and formed by processing a single tubular member. The cover member includes a protrusion having a first notch extending in a longitudinal direction in a first region including a distal end of the tubular member, the protrusion being formed by causing at least a portion of the first region to deform in a direction in which the first region is away from the fiber core in a radial direction; and a large diameter section having a second notch extending in the longitudinal direction in a second region of the tubular member, the second region being located at a proximal side relative to the first region, the large diameter section being formed by compressing the second region in the longitudinal direction and folding the second region into a shape that protrudes radially outward.

Another aspect of the present disclosure provides a method for manufacturing a scanning optical fiber. The method includes: forming a protrusion from a first region of a tubular member that covers a fiber core, the first region including a distal end of the tubular member; and forming a large diameter section from a second region of the tubular member, the second region being located at a proximal side relative to the first region. The forming the protrusion includes forming a first notch extending in a longitudinal direction in the first region, and causing at least a portion of the first region to deform in a direction in which the first region is away from the fiber core in a radial direction. The forming the large diameter section includes forming a second notch extending in the longitudinal direction in the second region, and compressing the second region in the longitudinal direction and folding the second region into a shape that protrudes radially outward.

### BRIEF DESCRIPTION OF DRAWINGS

FIG. 1 illustrates the overall configuration of a light treatment system according to an embodiment of the present disclosure.

FIG. 2A is a side view of a scanning optical fiber according to an embodiment of the present disclosure.

FIG. 2B is a front view of the scanning optical fiber in FIG. 2A, as viewed from the distal side.

FIG. 3A is a cross-sectional view of the scanning optical fiber and illustrates the arrangement of two protrusions of a large diameter section.

FIG. 3B is a cross-sectional view of the scanning optical fiber and illustrates the arrangement of three protrusions of the large diameter section.

FIG. 3C is a cross-sectional view of the scanning optical fiber and illustrates the arrangement of four protrusions of the large diameter section.

FIG. 4 illustrates a method for manufacturing the scanning optical fiber.

FIG. 5A is an end view of a tubular member and illustrates an example of a first notch formed in step S2.

FIG. 5B is an end view of the tubular member and illustrates another example of the first notch formed in step S2.

FIG. 5C is a side view illustrating an example of an operation section formed by the first notch in FIG. 5A or FIG. 5B.

FIG. 6A is an end view of the tubular member and illustrates another example of the first notch formed in step S2.

FIG. 6B is a partial perspective view of the tubular member having the first notch in FIG. 6A.

FIG. 7A is a partial side view of the tubular member and illustrates an example of second notches formed in step S4.

FIG. 7B is a partial side view of the tubular member and illustrates another example of the second notches formed in step S4.

FIG. 8 is a flowchart of a light treatment method using the scanning optical fiber.

### DESCRIPTION OF EMBODIMENTS

A scanning optical fiber, a laser irradiation device, and a method for manufacturing the scanning optical fiber according to an embodiment of the present disclosure will be described below with reference to the drawings.

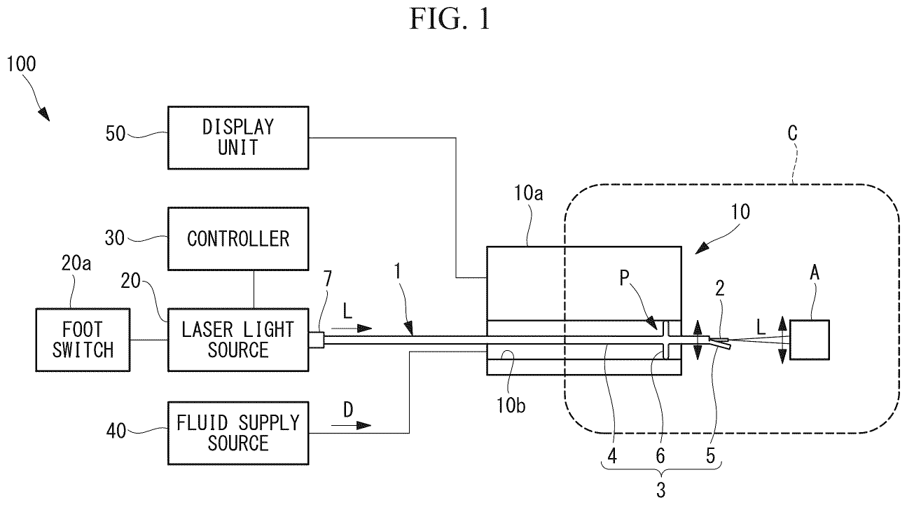

FIG. 1 illustrates an example of a system to which a scanning optical fiber 1 according to this embodiment is applied. A system 100 is a lithotripsy system that uses laser light L to fragment a calculus serving as a treatment target A, and includes the scanning optical fiber 1, a medical tube 10, a laser light source 20, a controller 30, and a fluid supply source 40. The scanning optical fiber 1 and the laser light source 20 constitute the laser irradiation device according to this embodiment.

The medical tube 10 is an endoscope having a long and flexible insertion section 10a. An image inside a body C acquired by the endoscope 10 may be displayed on a display unit 50. The endoscope 10 has a channel 10b that extends through the insertion section 10a in the longitudinal direction and into which the scanning optical fiber 1 is inserted.

The laser light source 20 is, for example, a laser oscillator and is optically connected to the proximal end of the scanning optical fiber 1. In response to an operation performed on a foot switch 20a, the laser light source 20 outputs the pulsed laser light L for treating the target A. The laser light L is, for example, infrared light.

The controller 30 controls the conditions, such as the pulse frequency, of the laser light L output by the laser light source 20.

The fluid supply source 40 is fluidically connected to the proximal end of the channel 10b and supplies a perfusate D, such as a physiological saline solution, to the channel 10b. For example, the fluid supply source 40 includes a container for holding the perfusate D and a tube for connecting the container and the channel 10b, and supplies the channel 10b with the perfusate D naturally dripping from the container.

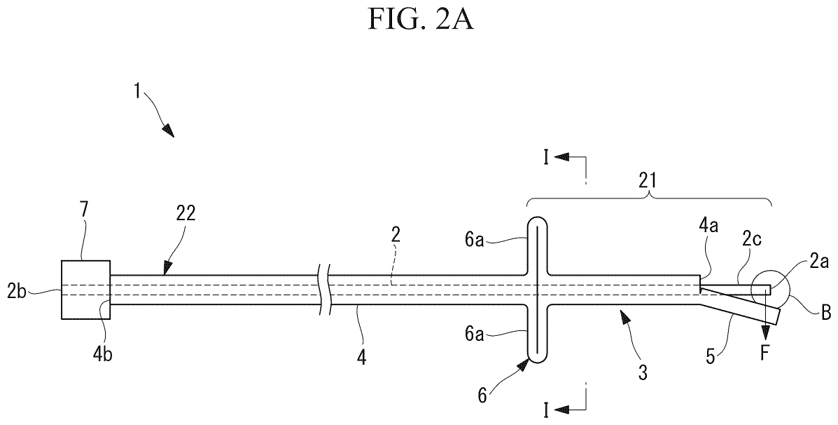

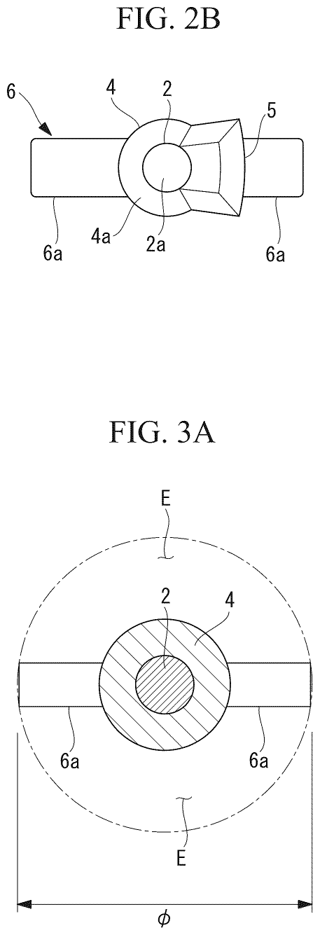

As shown in FIG. 2A and FIG. 2B, the scanning optical fiber 1 includes a long fiber core 2 and a cover member 3 that covers at least a portion of the fiber core 2.

The fiber core 2 has a distal region 21 including a distal end 2a and a proximal region 22 including a proximal end 2b. Similar to a fiber core of a known optical fiber, the fiber core 2 has a core and cladding, and transmits light from the proximal end 2b to the distal end 2a.

The cover member 3 is a long tubular member that is disposed radially outward of the core 2 to protect the core 2, and is composed of a flexible material that is deformable, such as resin.

The cover member 3 has a long tubular main section 4, a protrusion 5 located at the distal side of the main section 4, and a large diameter section 6 provided at an intermediate position of the main section 4 in the longitudinal direction. The cover member 3 is formed of a single seamless member, so that the main section 4, the protrusion 5, and the large diameter section 6 extend continuously without seams.

The main section 4 covers at least a portion of the distal region 21 excluding an end portion 2c of the core 2 including the distal end 2a. As will be described later, the distal region 21 is a vibration region that vibrates in the radial direction about the position of the large diameter section 6 acting as a fulcrum P. Preferably, the main section 4 covers the core 2 from the distal region 21 to the proximal region 22, and a proximal end 4b of the main section 4 is disposed at or in the vicinity of the proximal end 2b of the core 2.

The protrusion 5 is an operation section that vibrates the vibration region 21 in the radial direction by causing a contraction force F of a bubble B generated at the distal end 2a by the laser light L to act on the distal end 2a. The pulsed laser light L output from the distal end 2a increases the temperature of a liquid medium surrounding the distal end 2a, thereby generating the bubble B at the distal end 2a. The bubble B repeatedly undergoes generation, growth, contraction, and collapse in synchronization with the pulsed laser light L.

The operation section 5 protrudes from a distal end 4a of the main section 4, is disposed only at one side of the end portion 2c in the radial direction, and is arranged alongside the end portion 2c in the radial direction. The operation section 5 is disposed at a position where the bubble B can come into contact therewith from the distal end 2a with a distance therebetween in the radial direction, and retains the bubble B between the distal end 2a and the operation section 5. Accordingly, the operation section 5 causes the contraction force F to act on the distal end 2a toward the operation section 5 during contraction of the bubble B.

The large diameter section 6 is provided toward the proximal side relative to the distal end 4a. The large diameter section 6 is folded in the longitudinal direction of the main section 4 into a shape that protrudes radially outward, so as to have an outer diameter larger than that of the main section 4. Thus, the large diameter section 6 limits radial movement of the proximal end of the vibration region 21 within the channel 10b, and retains the vibration region 21 in a cantilevered manner. Accordingly, the large diameter section 6 fixes the proximal end of the vibration region 21 within the channel 10b and functions as a fulcrum section forming the fulcrum P for the vibration of the vibration region 21.

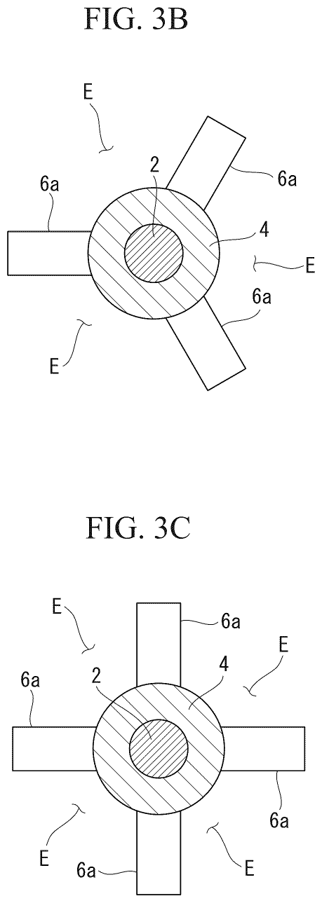

In detail, as shown in FIG. 3A to FIG. 3C, the fulcrum section 6 has at least two protrusions 6a arranged with a distance therebetween in the circumferential direction. FIG. 3A, FIG. 3B, and FIG. 3C are cross-sectional views of the scanning optical fiber 1 taken along line I-I in FIG. 2A, and respectively illustrate fulcrum sections 6 having two, three, and four protrusions 6a. The at least two protrusions 6a are preferably arranged evenly in the circumferential direction.

Each protrusion 6a is folded in the longitudinal direction of the main section 4 such that a distal half and a proximal half of the protrusion 6a protrude in the radial direction and face each other in the longitudinal direction of the main section 4, and protrudes radially outward from an outer side surface of the main section 4. The at least two protrusions 6a protrude from the main section 4 by the same amount, and the fulcrum section 6 retains the proximal end of the vibration region 21 serving as the fulcrum P substantially on the central axis of the channel 10b.

A space E is formed between two of the protrusions 6a adjacent to each other in the circumferential direction. Each space E functions as a flow path through which the perfusate D can travel in the longitudinal direction of the main section 4.

An outer diameter φ of the fulcrum section 6 is preferably equal to the inner diameter of the channel 10b, and may be larger than the inner diameter of the channel 10b. As shown in FIG. 3A, the outer diameter φ is the diameter of a circle inscribed by radially outer ends of the at least two protrusions 6a. The fulcrum section 6 can come into contact with the inner surface of the channel 10b at multiple positions arranged in the circumferential direction, so as to be capable of stably retaining the fulcrum P at a fixed position in the radial direction within the channel 10b.

The scanning optical fiber 1 may further include a connector 7 for optically connecting the proximal end 2b of the core 2 to the laser light source 20. The connector 7 is a known optical connector attachable to and detachable from the laser light source 20, and is at least connected to the proximal end 2b of the core 2. The connector 7 is also preferably connected to the proximal end (i.e., the proximal end 4b) of the cover member 3.

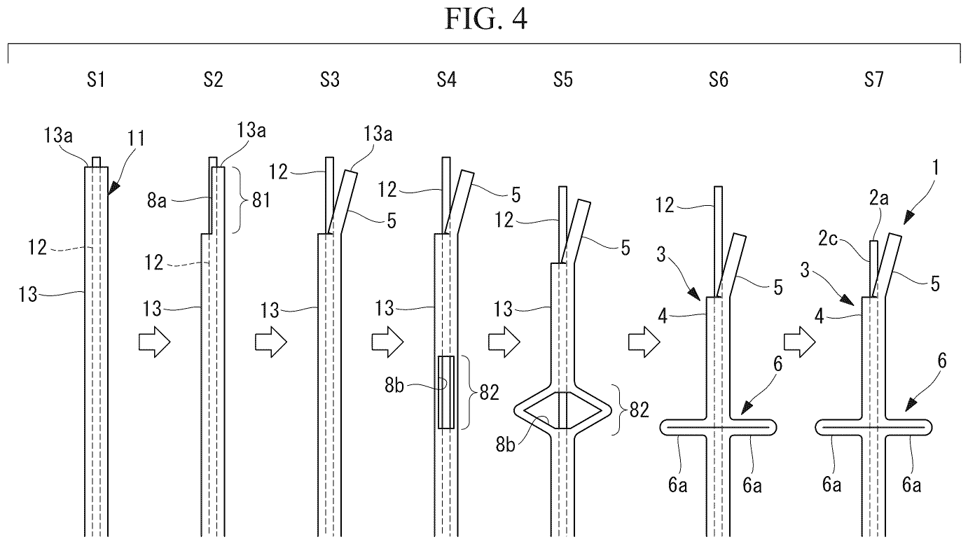

FIG. 4 illustrates a method for manufacturing the scanning optical fiber 1. The manufacturing method includes steps S1 to S7.

First, an optical fiber 11 having a fiber core 12 covered with a cover member 13 substantially over the entire length is prepared (step S1). The optical fiber 11 is, for example, a commercially-available product, and the cover member 13 is tubular member that is tubular over the entire length from a distal end 13a to a proximal end.

Subsequently, the operation section 5 is formed from a first region 81 of the tubular member 13 (steps S2 and S3). The first region 81 is an end region of the tubular member 13 including the distal end 13a.

In detail, a first notch 8a having a predetermined first length and extending in the longitudinal direction from the distal end 13a toward the proximal side is formed in the first region 81 (step S2). The predetermined first length is determined in accordance with a desired length of the operation section 5. Then, the first region 81 is peeled from the surface of the core 12, and at least a portion of the first region 81 is deformed in a direction in which the first region 81 is away from the core 12 in the radial direction (step S3). In FIG. 4, the first region 81 is bent radially outward at the proximal end thereof, thereby forming the operation section 5 that is inclined relative to the core 12 in the direction away from the core 2 with approaching the distal end 13a.

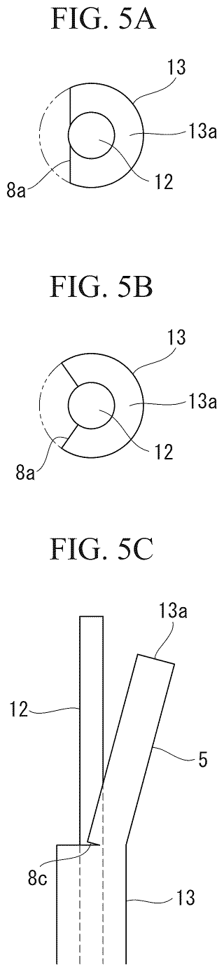

In step S2 in FIG. 4, the first notch 8a is a cutout having a width in the circumferential direction and is obtained by cutting a circumferential portion (e.g., ½ to ¾) of the first region 81. FIG. 5A and FIG. 5B are end views of the tubular member 13 having the first notch 8a, as viewed from the distal side, and each illustrate an example of the first notch 8a. In this case, the operation section 5 is formed of the remaining portion of the first region 81 and protrudes from a circumferential portion of an annular distal end surface of the main section 4 (see FIG. 2B). As shown in FIG. 5C, the operation section 5 may be spread radially outward by forming a notch 8c, in the radial direction, at the proximal end of the operation section 5. Alternatively, for example, the proximal end of the operation section 5 may be fixed by using an adhesive or by welding.

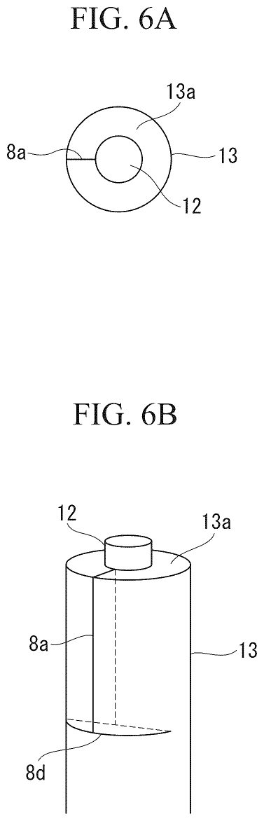

FIG. 6A and FIG. 6B illustrate another example of the first notch 8a. The first notch 8a in FIG. 6A and FIG. 6B is a slit without a width or with a small width. In this case, the operation section 5 is formed from the entire first region 81 without cutting a portion of the first region 81. In order to form the operation section 5, a slit 8d in the radial direction may further be formed at the proximal side of the first notch 8a.

Subsequently, the fulcrum section 6 is formed from a second region 82 of the tubular member 13 (steps S4 to S6). The second region 82 is located toward the proximal side relative to the first region 81.

In detail, at least two second notches 8b having a predetermined second length and extending in the longitudinal direction are formed in the second region 82 (step S4). The predetermined second length is determined in accordance with a desired outer diameter φ of the fulcrum section 6. The at least two second notches 8b are formed at positions separated from each other by a distance in the circumferential direction, and are preferably formed at positions separated from each other by an equal distance in the circumferential direction. With the at least two second notches 8b, the second region 82 is divided into at least two portions in the circumferential direction.

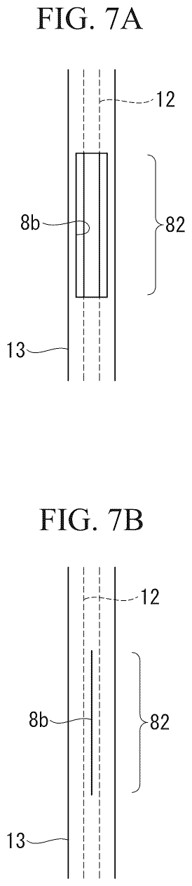

FIG. 7A and FIG. 7B illustrate an example of the second notches 8b. As shown in FIG. 7A, each second notch 8b is an opening having a width in the circumferential direction, and may be formed by cutting a circumferential portion of the second region 82. Alternatively, as shown in FIG. 7B, the second notch 8b may be a slit without a width or with a small width.

In steps S2 and S4, for example, the first notch 8a and the second notches 8b mentioned above are formed by using a laser or a cutter.

Subsequently, the second region 82 is compressed in the longitudinal direction so as to be folded into a shape that protrudes radially outward (steps S5 and S6). In detail, the individual portions of the second region 82 are folded about the center in the longitudinal direction thereof, thereby forming the protrusions 6a. The compression of the second region 82 is performed by, for example, moving a distal part of the second region 82 of the tubular member 13 toward the proximal side relative to the core 12. In FIG. 4, each portion is completely folded until the distal half and the proximal half thereof come into contact with each other, whereby the protrusion 6a, which is flat, is formed. Each portion may be folded into another shape, such as a V shape.

Then, a distal end portion of the core 12 is cut, thereby forming the end portion 2c having an appropriate length (step S7).

After step S6, the operation section 5 and the fulcrum section 6 may be fixed in shape by using an arbitrary method, such as welding. For example, the proximal end of the operation section 5 may be melted by heat and subsequently cured, so as to be fixed in a bent shape to the core 2.

Next, a phototherapy method using the scanning optical fiber 1 and the phototherapy system 100 will be described.

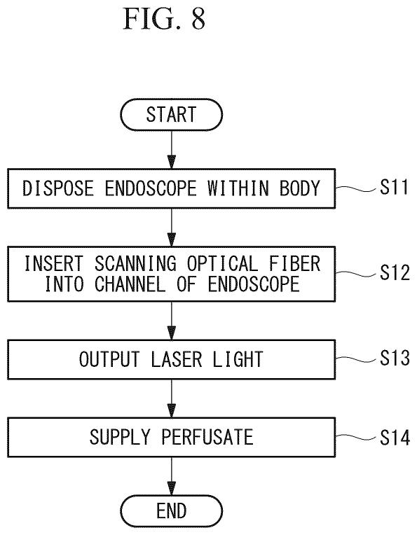

As shown in FIG. 8, the phototherapy method includes step S11 for disposing the endoscope 10 within the body C, step S12 for inserting the scanning optical fiber 1 into the channel 10b of the endoscope 10, step S13 for irradiating the target A with the laser light L, and step S14 for supplying the perfusate D.

An operator, such as a surgeon, inserts the endoscope 10 into a kidney through the urethra (step S11).

Then, the operator inserts the scanning optical fiber 1 into the channel 10b, so as to dispose the distal end 2a of the core 2 and the operation section 5 outside the channel 10b and to dispose the fulcrum section 6 inside the channel 10b (step S12).

Subsequently, the operator steps on the foot switch 20a to cause the laser light source 20 to start outputting the laser light L (step S13). The pulsed laser light L is radiated onto the target A from the distal end 2a, thereby fragmenting a calculus serving as the target A.

In this case, the pulsed laser light L is repeatedly output from the distal end 2a, so that the bubble B is repeatedly generated and collapsed at the distal end 2a, whereby the operation section 5 causes the force F to act on the distal end 2a every time the bubble B contracts. Consequently, the vibration region 21 vibrates about the position of the fulcrum section 6 within the channel 10b acting as the fulcrum P, whereby the laser light L is scanned over the target A.

Step S14 is performed concurrently with step S13 and involves the operator supplying the perfusate D to the channel 10b from the fluid supply source 40 (step S14). The perfusate D travels through the space E of the fulcrum section 6 within the channel 10b, and is discharged from a distal-end opening of the channel 10b. The discharged perfusate D enables improvement of poor visibility of the endoscope 10 caused by fragments of the calculus so as to achieve a clear visual field, and also suppresses a temperature increase in the kidney caused by the laser light L.

Accordingly, in this embodiment, the fulcrum section 6 fixes the fulcrum P of the vibration region 21 within the channel 10b while ensuring a flow path within the channel 10b in accordance with the space E. This enables both fixation of the fulcrum P and perfusion.

Moreover, in this embodiment, the operation section 5 and the fulcrum section 6 are formed of the same component as the main section 4, and are each formed from a portion of the cover member 13 by processing the cover member 13 covering the core 12. Specifically, for example, unlike a case where an optical fiber, an operation section, and a fulcrum section that are separately prepared are assembled, the manufacturing process of the scanning optical fiber 1 does not require an assembly process of such components. Therefore, the scanning optical fiber 1 can be easily manufactured.

In the case of a scanning optical fiber manufactured by attaching an operation section and a fulcrum section that are separately prepared to an optical fiber, there is a possibility that the operation section and the fulcrum section may become detached from the optical fiber. This embodiment can prevent such a problem and can provide a highly-reliable scanning optical fiber 1.

Although the main section 4 covers the core 2 from the distal region 21 to the proximal region 22 in the above embodiment, the main section 4 may terminate at any position at the proximal side relative to the fulcrum section 6. In order to prevent positional displacement of the operation section 5 and the fulcrum section 6 in the longitudinal direction relative to the core 2, the main section 4 preferably extends to the proximal side of the fulcrum section 6. For example, the proximal region 22 may protrude from the proximal end 4b of the main section 4, and the connector 7 does not have to be connected to the proximal end 4b.

Although a medical tube serves as the endoscope 10 in the above embodiment, the medical tube may be any long medical device that has the channel 10b, and may be, for example, a catheter.

Although the embodiment of the present disclosure and the modifications thereof have been described above, the present disclosure is not limited thereto and are modifiable, as appropriate, within a range not departing from the scope of the present disclosure.

For example, the scanning optical fiber 1 and the system 100 are not limited to lithotripsy and are applicable to any treatment involving irradiating the target A with light. In particular, the scanning optical fiber 1 and the system 100 may be suitably applied to treatment performed while supplying a liquid or gas. The fluid supplied to the channel 10b by the fluid supply source 40 is also appropriately selected depending on the type of treatment. Specifically, the fluid supply source 40 may supply a different liquid or gas to the channel 10b.

The scanning optical fiber 1 is not limited to treatment and may be used for another purpose that involves irradiating an object with laser light while scanning the laser light.

### REFERENCE SIGNS LIST

1 scanning optical fiber
2, 12 fiber core
2a distal end
2c end portion
21 distal region
23
22 proximal region
3 cover member
4 main section
5 operation section (protrusion)
6 fulcrum section (large diameter section)
7 connector
81 first region
82 second region
8a first notch
8b second notch
10 endoscope (medical tube)
10b channel
13 tubular member
L laser light
B bubble

1. A scanning optical fiber comprising:
a fiber core having a proximal region and a distal region; and
a cover member comprising a single seamless member and covering at least a portion of the fiber core,
wherein the cover member includes
a tubular main section that covers at least a portion of the distal region excluding an end portion including a distal end of the fiber core,
a protrusion that protrudes from a distal end of the main section at only one side of the fiber core in a radial direction and that is arranged alongside the end portion in the radial direction, and
a large diameter section provided at a proximal side relative to the distal end of the main section and folded in a longitudinal direction of the main section into a shape that protrudes radially outward.

2. The scanning optical fiber according to claim 1, wherein the cover member covers the fiber core from the distal region to the proximal region.

3. The scanning optical fiber according to claim 2, further comprising a connector connected to a laser light source,
wherein the connector is connected to respective proximal ends of the fiber core and the cover member.

4. The scanning optical fiber according to claim 1, wherein the protrusion comes into contact with a bubble generated by laser light at the distal end of the fiber core and retains the bubble between the distal end of the fiber core and the protrusion.

5. The scanning optical fiber according to claim 1, wherein the large diameter section has an outer diameter equal to an inner diameter of a channel of a medical tube into which the scanning optical fiber is inserted, and retains a proximal end of the distal region at a fixed position in the radial direction within the channel.

6. A scanning optical fiber comprising:
a fiber core having a proximal region and a distal region; and
a cover member formed by processing a single tubular member and covering at least a portion of the fiber core,
wherein the cover member includes
a protrusion having a first notch extending in a longitudinal direction in a first region including a distal end of the tubular member, the protrusion being formed by causing at least a portion of the first region to deform in a direction in which the first region is away from the fiber core in a radial direction, and
a large diameter section having a second notch extending in the longitudinal direction in a second region of the tubular member, the second region being located at a proximal side relative to the first region, the large diameter section being formed by compressing the second region in the longitudinal direction and folding the second region into a shape that protrudes radially outward.

7. The scanning optical fiber according to claim 6, wherein the cover member covers the fiber core from the distal region to the proximal region.

8. The scanning optical fiber according to claim 7, further comprising a connector connected to a laser light source,
wherein the connector is connected to proximal ends of the fiber core and the cover member.

9. The scanning optical fiber according to claim 6, wherein the protrusion comes into contact with a bubble generated by laser light at the distal end of the fiber core and retains the bubble between the distal end of the fiber core and the protrusion.

10. The scanning optical fiber according to claim 6, wherein the large diameter section has an outer diameter equal to an inner diameter of a channel of a medical tube into which the scanning optical fiber is inserted, and retains a proximal end of the distal region at a fixed position in the radial direction within the channel.

11. A laser irradiation device comprising:
a laser light source that emits laser light; and
a scanning optical fiber connected to the laser light source,
wherein the scanning optical fiber includes
a connector attachable to and detachable from the laser light source,
a fiber core connected to the connector and having a proximal region and a distal region, and
a cover member formed of a single seamless member and covering at least a portion of the fiber core, and
wherein the cover member includes
a tubular main section that covers at least a portion of the distal region excluding an end portion including a distal end of the fiber core,
a protrusion that protrudes from a distal end of the main section at only one side of the fiber core in a radial direction and that is arranged alongside the end portion in the radial direction, and
a large diameter section provided at a proximal side relative to the distal end of the main section and folded in a longitudinal direction of the main section into a shape that protrudes radially outward.

12. The laser irradiation device according to claim 11, wherein the cover member covers the fiber core from the distal region to the proximal region.

13. The laser irradiation device according to claim 12, further comprising a connector connected to the laser light source,
wherein the connector is connected to respective proximal ends of the fiber core and the cover member.

14. The laser irradiation device according to claim 11, wherein the protrusion comes into contact with a bubble generated by laser light at the distal end of the fiber core and retains the bubble between the distal end of the fiber core and the protrusion.

15. The laser irradiation device according to claim 11, wherein the large diameter section has an outer diameter equal to an inner diameter of a channel of a medical tube into which the scanning optical fiber is inserted, and retains a proximal end of the distal region at a fixed position in the radial direction within the channel.

16. A laser irradiation device comprising:
a laser light source that emits laser light; and a scanning optical fiber according to claim 1.
